(19) United States
(12) Patent Application Publication
(10) Pub. No.: US 2003/0110208 A1
(43) Pub. Date: Jun. 12, 2003

(54) Processing data across packet boundaries

(75) Inventors: Daniel Wyschogrod, Newton, MA (US); Alain Arnaud, Newton, MA (US); David Eric Berman Lees, Lexington, MA (US)

Correspondence Address: MARGER JOHNSON & MCCOLLOM PC, 1030 SW MORRISON STREET, PORTLAND, OR, 97205, US

(73) Assignee: Raqia Networks, Inc., Newton, MA

(21) Appl. No.: 10/350,540

(22) Filed: Jan. 24, 2003

Related U.S. Application Data
(63) Continuation-in-part of application No. 10/005,462, filed on Dec. 3, 2001.
(63) Continuation-in-part of application No. 10/217,592, filed on Aug. 8, 2002.
(60) Provisional application No. 60/322,012, filed on Sep. 12, 2001.
(60) Provisional application No. 60/351,600, filed on Jan. 25, 2002.
(60) Provisional application No. 60/357,384, filed on Feb. 15, 2002.

(51) Int. Cl. G06F 15/16

(52) U.S. Cl. 709/202

(57) ABSTRACT

Data that spans multiple packets is processes. A finite state machine is used to process the data in each packet and the “state” of a finite state machine is saved after processing a packet. The saved state is stored with information that identifies the particular data stream from which the packet originated. This means that a state machine engine (hardware implementation of the finite state machine) is not tied to a particular data stream. The present invention makes it possible to utilize state machine co-processors very efficiently in a multiple engine/multiple data stream system.

### RELATED APPLICATIONS

1) This application is a non provisional of application Ser. No. 60/351,600 Jan. 25, 2002

2) This application is a continuation in part of application Ser. No. 10/217,592 filed Aug. 8, 2002

3) Application Ser. No. 10/217,592 is a Non-Provisional of application Ser. No. 60/357,384 filed Feb. 15, 2002

4) Application Ser. No. 10/217,592 is a Non-Provisional of application Ser. No. 60/322,012 filed Sep. 12, 2001

5) Application Ser. No. 10/217,592 is a continuation-in-part of application Ser. No. 10/005,462 filed Dec. 3, 2002

Priority of the above five applications is claimed and their specification and drawings are hereby incorporated herein by reference.

### FIELD OF THE INVENTION

The present invention relates to communication systems and more particularly to communications systems that transmit information utilizing packets.

### BACKGROUND OF THE INVENTION

Many existing communication protocols transit information in “packets”. In the TCP communication protocol, a virtual “connection” is established between client and server processes running on different machines and packets are sent over this connection. Applications and various algorithms within the TCP/IP stack on the host machine break data into packets for transmission over the connection. Data traveling in one direction forms a stream of packets through which an application can send as much data as it wishes until such time as the connection is closed. Different TCP applications tend to use different TCP services, and the duration of connections vary. Http client requests tend to be of short duration while telnet sessions may be very long. The TCP protocol is well known and is for example described in a book entitled “TCP/IP Illustrated, Volume 1” by W. R. Stevens, published by Addison-Wesley, 1994, the contents of which is hereby incorporated herein by reference.

Ethernet packets are a well known type of packet used in communication systems. In Ethernet packets the data portion of each packet contains up to 1500 bytes (see the 802.3 Standard published by the IEEE), but many factors can cause this number to be much less including applications involving keyboard typing, programs closing sockets, fragmentation, existence of PPP or other protocols between nodes on the network path, etc. Packet size, that is, the placement and location of packet boundaries can be considered as arbitrary from the point of view of applications that inspect packet content.

There are applications which require a system to inspect the contents of TCP/IP packets at a high data rate of speed. These applications include but are not limited to such applications as Server Load Balancing, Intrusion Detection and XML routing. Many current applications assume that the content that must be inspected is at the beginning packet of a connection and therefore only the content of the first packet is inspected. Other current applications assume that the first few packets need to be inspected and that they can be collected and concatenated and then searched. In both of these cases, packet boundaries need not be considered during the actual inspection process since in the first case only one packet is examined and in the second case the packets are concatenated.

While many protocols like http typically use only one Ethernet packet to make a “standard” client request, in http version 1.1, persistent connections have become a standard permitting the client to send multiple http requests in a single stream which can easily cross packet boundaries. In many applications such as for example, intrusion detection, telnet sessions must be monitored and large numbers of packets need to be examined. Furthermore patterns being searched may cross packet boundaries. Saving multiple packets and joining them to facilitate the search can lead to large memory requirements for buffering and frequently introduces unacceptable latencies. If one is saving and joining packets, in some cases, an entire stream may need to be buffered and concatenated . This can occur if one is looking for large patterns such as an attack involving a buffer overflow.

It is also noted that a communication channel may simultaneously carry packets from many different connections. The packets that comprise one particular connection may be interspersed among packets that belong to other connections.

### SUMMARY OF THE INVENTION

The present invention is directed to processing data that spans multiple packets. A finite state machine is used to process the data in each packet and the “state” of a finite state machine is saved after processing a packet. The saved state is stored with information that identifies the particular data stream from which the packet originated. This means that a state machine engine (hardware implementation of the finite state machine) is not tied to a particular data stream. The present invention makes it possible to utilize state machine co-processors very efficiently in a multiple engine/multiple data stream system.

### BRIEF DESCRIPTION OF THE FIGURES

FIG. 1A is an overall block diagram of a first embodiment of the invention.

FIG. 1B is a block flow diagram explaining the operation of the system shown

FIG. 2 is a state diagram showing a Deterministic Finite-State Automaton.

FIG. 3 is a simplified example of the contents of string of packets.

FIG. 4 is a time line diagram.

FIGS. 5A, 5B and 5C are tables showing the sequence of steps in the operation of a system.

### DETAILED DESCRIPTION

In the following paragraphs, a preferred embodiment of the invention will first be described in a general overall fashion. The general description will be followed by a more detailed description. Alternate embodiments will also be described.

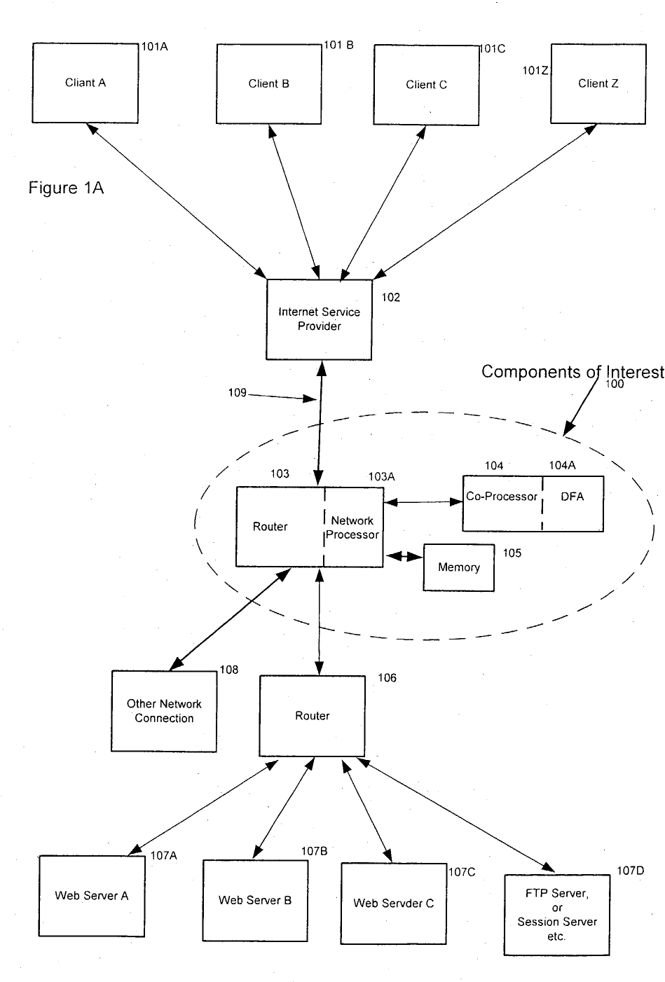

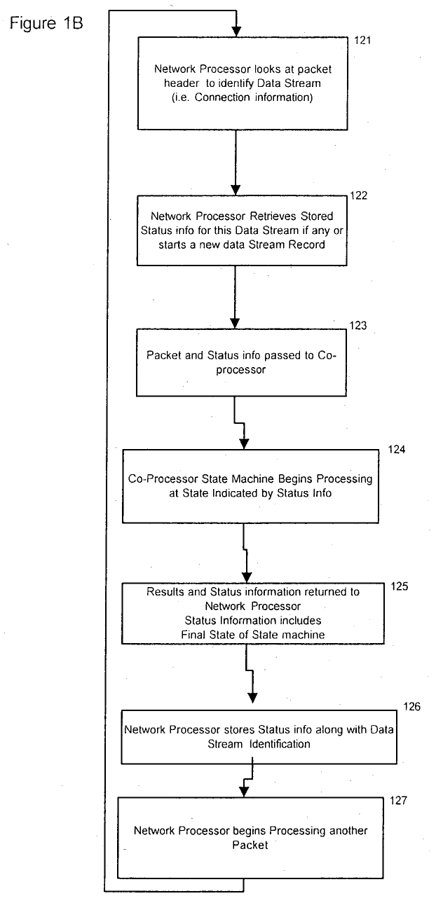

An example of a system which incorporates a first embodiment of the invention is illustrated by the block diagram in FIG. 1A. The system shown in FIG. 1A is merely illustrative and many alternative system configurations are possible.

The system shown in FIG. 1A includes a number of client systems 101A to 101Z which communicate with a number of conventional web servers, FTP servers, Session Servers, etc. 107A to 107D. The exact number of clients and the exact number and type of servers is not particularly relevant to the invention. A typical system will have many clients 101 and at least one or more servers 107.

Each of the clients 101 generates and receives packets of information. An Internet Service Provider system 102 connects the clients 101 to a communication channel 109. Packets from and to all of the clients 101 pass through a single common communication channel 109. The common communication channel 109 includes components such as internet service provider 102, router 103 and router 106 and it may have other network connections 108. A practical size network may contain many such components.

The overall configuration of the system shown in FIG. 1A is merely illustrative. However, it is important to note that packets that are being transmitted between a number of different units (e.g. clients 101A to 101Z and servers 107A to 107D) pass through a common communication channel 109. In the communication channel 109, the packets from the different clients and servers are interspersed. The system shown in FIG. 1A operates in accordance with the well known TCP/IP protocol. The addresses within the packets themselves are used to direct the packets to the correct client or server. Such operations are conventional and common in modern day networks.

The term “connection” is used to denote a particular stream of packets between two points, for example between a particular client 101 and a particular port on a particular web server 107. A sequence of packets containing information is transmitted through each “connection”. It is important to note that packets that are part of several “connections” are interspersed in communication channel 109.

The components of particular interest to the present invention are indicated by the dotted circle 100. Router 103 interrogates the header information in the packets that it receives to identify the “connection” to which a particular packet belongs and to route the particular packet. That is, as is conventional, router 103 uses the connection information that it derives from packet headers to direct packets to the correct router or network connection.

In the specific embodiment shown herein, the router 103 includes a network processor 103A. The network processor 103A can for example be an Intel model IXP1200 processor. Such processors are commonly used in network switches and routers. For example see, a publication entitled “Intel WAN/LAN Access Switch Example Design for the Intel IXP1200 Network Processor”, An Intel Application Note, Published by the Intel Corporation, May 2001. The contents of the above referenced application note is hereby incorporated herein in its entirety.

The network processor 103A is connected to a co-processor 104 and to a memory 105. The Intel IXP1200 has a 32 bit, 66 MHz PCI bus and it can transfers 32 bits in parallel to co-processor 104.

Some applications (for example some load balancing applications) require more information than the information in the headers of the packets being processed. That is, by obtaining information from the body of the packet, the system can more efficiently process the packets. Co-processor 104 includes a conventional “Deterministic Finite-State Automaton” (DFA) 104A which can scan bits or bytes in a packet to detect a particular patterns of bits or bytes.

The internal details of the DFA 104A are not particularly relevant to the present invention. DFAs are well known in the art. For example, see a book entitled “Compilers Principles Techniques and Tools” by A. V. Aho, R. Sethi, J. D. Ullman, Addison-Wesley, 1986, the contents of which are hereby incorporated herein by reference. Also see co-pending applications application Ser. No. 10/217,592 filed Aug. 8, 2002, and co-ending application Ser. No. 10/005,462 filed Dec. 3, 2002, the content of which is hereby incorporated herein by reference. The DFA 104A in co-processor 104 can be implemented by programming, or it can be a special purpose integrated circuit designed to implement a DFA. The particular manner that the DFA 104A in co-processor 104 is implemented can be conventional.

Network processor 103A hands the contents of packets to co-processor 104 and the DFA 104A in co-processor 104 scans the packets to find a matching pattern of bits. As indicated above, the Intel IXP1200 has a 32 bit, 66 MHz PCI bus and it can transfers 32 bits in parallel to co-processor 104. Typically a DFA operates on a string of bits one byte at a time. Co-processor 104 buffers the bytes that are transferred in parallel and supplies them to the DFA 104A, one byte at a time in a conventional manner. If the packets being operated on contain, more than 32 bits (i.e. four bytes), several parallel transfers are required to transfer an entire packet from network processor 103A to co-processor 104. As indicated below, certain state information is also transferred from the network processor 103A to co-processor 104. Conventional signaling between the network processor 103A and the co-processor 104 is used to indicate what is being transferred and to store the information in appropriate buffers for further processing. The required state information is transferred prior to the transfer of the actual packet contents, and the transfer of parts of the packet after the first part can take place while the DFA 104A is processing the first part of the packet. Such transfer and buffering operations are done in a conventional manner.

It should be recognized that the packets that form each particular “connection” in communication channel 109 are interspersed with packets from other different “connections”. Thus, packets for one particular connection may not be processed sequentially by co-processor 104.

It is also important to note that in some cases, the bit (or byte) pattern that one is seeking to locate, may cross over between successive packets in a particular connection. The present invention is directed to dealing with this situation.

In order to process packets in a particular connection across a packet boundary, the DFA 104A must begin processing the bits of the second packet from the state where the DFA 104A finished processing the bits from the first packet. That is, if, for example, a DFA 104A goes from state “0” to state “200” processing the bits in one packet, to continue processing bits across the packet boundary, the DFA 104A must start processing the bits from the second packet from state “200”.

With the system shown in FIG. 1A, this is done as follows: Network processor 103A transfers a packet to co-processor 104 which processes the packet using a DFA 104A. When the processing is complete (that is, when all the bytes of the packet have been processed by the DFA), the co-processor gives back to network processor 103A, the result (i.e. and indication of whether or not the desired pattern detected) plus an identification of that state where the DFA 104A operation finished. Network processor stores in memory 105 the fact that a packet from a particular connection was processed and that at the end of the processing the DFA 104A was at a particular identified state. Thus, DFA state information is tied to packets as they are transferred from network processor 103A to co-processor 104. When state information is given to co-processor 104 along with a packet, the co-processor 104 begins the operation of DFA 104A at the state indicated by the transferred information.

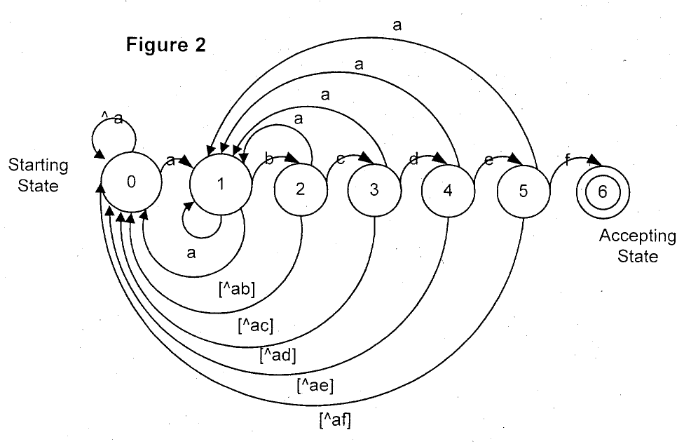

When the network processor 103A gives the co-processor 104, the next packet from the same connection, it also give co-processor 104 the information from memory 105 indicating where processing from the previous packet terminated. Processing by DFA 104A then begins from the indicated state. That is, with respect to FIG. 2, processing normally begins at state “0”; however, if for example, co-processor receives a packet along with an indication that the processing of the prior packet from the same connection terminated at state “3”, processing of the transferred packet will begin at state “3”. That is, the controls for the DFA merely begins operation at state 3 rather than at state 0.

It is noted that between processing successive packets from the same connection, the co-processor 104 may have processed packets from other connections. Thus, the operation is very different from a system which concatenates packets together and processes then as a long string.

The above sequence of operations is illustrated in the flow diagram in FIG. 1B. A indicated by block 121, the operation begins when processor 103A examines a packet and reads the header information to determine the connection to which the packet belongs. Such an operation is conventional. The processor 103A then retrieves the stored status information for this connection and it passes the packet and the status to the co-processor 104 and then to DFA 104A as indicated by block 123. If there is no stored status information, the processor 103A indicates to the co-processor 104 and thus to the DFA 104A that the processing should start at state 0.

As indicated by block 124, the DFA 104A in co-processor 104 processes the bits in the packet beginning at the state indicated in the status information received from the network processor 103A. The results, including the state of the DFA 104A at the end of the operation are then returned to the processor 103A as indicated by block 125. As indicated by block 126, the processor 103A stores the final state of the DFA 104A in memory 105. The processor 103A them goes on to the next packet as indicated by block 127 and the process repeats.

An example of cross-packet pattern matching will now be described in more detail. The invention may be applied to arbitrary data formats. In this example a Deterministic Finite-State Automaton (DFA) 104A is used to search for patterns.

Using the system described herein patterns can be matched across packet boundaries. In this way matches can be found at any point in the stream of packets, even if the pattern crosses a packet boundary. This is accomplished by allowing the DFA 104A to start in an arbitrary state when handed a packet.

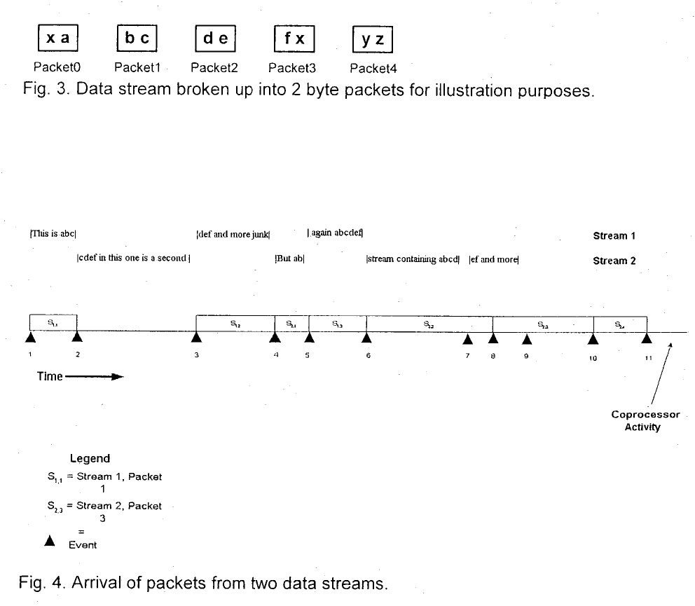

The following will illustrate this idea with a simple example. Assume that the regular expression which one is trying to match is ‘.*abcdef’ and suppose for illustration purpose that packets are only 2 bytes long as shown in FIG. 3. The DFA to recognize this pattern is shown by the state diagram in FIG. 2.

The DFA drawing includes failure transitions that returns to state 1 if the character being processed is not the next character in the sequence, but it is ‘a’ and the failure transition to the start state when the character is not the next character in the sequence and it is not ‘a’. For example in state 3, suppose the next character processed is ‘a’. Then a transition is made to state 1.

Assume an incoming data stream of ‘xabcdefxyz’ broken up into 5 packets as shown in FIG. 3. The first buffer has a state value of zero and the characters ‘xa’. The DFA is in state 1 after processing the first packet and this state is appended to the next packet to form a buffer containing characters ‘bc’. The second buffer is handed to the DFA along with the state value 1 and it is in state 3 after processing it. Packets are processed sequentially until the accepting state 6 is reached.

It is important to note that at the start of each packet, the DFA 104A processing engine starts at whatever state is contained in the buffer. For the simple case of a single data stream and a single engine, it is not necessary to save the state and restore the state. In such a simple case, it would be sufficient for the hardware to not reset the state at the end of each packet. However, attaching the state to the packet effectively allows the DFA processing engines to process packets from multiple data streams even though there is only one physical DFA 104A. The processing engine obtains its initial state from the data received from network processor 103A. In this way hardware resources can be used much more efficiently than dedicating a physical DFA engine to each data stream.

In the example given above, a classical DFA 104A is used, whose state is represented by a single integer. However, in an alternate embodiment a more complicated state machine is used involving storage of history of selected state transitions. Such an embodiment requires more than a single number to describe the state of the DFA.

For example, a somewhat more complicated alternate embodiment can be used to process Perl based regular expressions wherein capturing parentheses are allowed (see the text book by J. E. F. Friedl, “Mastering Regular Expressions” 2^{nd} edition, published by O'Reilly, 2002) . In such an embodiment, the start and end of each sub-expression must be found. This requires two memory locations for each subexpression to store the start/end byte offset positions, in effect storing the history of where the engine has been at previous positions in the input.

For such an embodiment up to 8 subexpressions and a total of 16 memory locations are required. In the above example, up to 16 locations of subexpression offsets plus the state must be stored. The subexpression offsets plus the DFA state are referred to as a state record, rather than simply ‘state’. The state record in general represents the complete state of the processing engine. The ‘state record’ allows the complete state of the machine to be restored so that an arbitrarily chosen processing engine may be used to process a particular buffer. (note a state machine working on packets from one particular connection is referred to as a virtual processing engine).

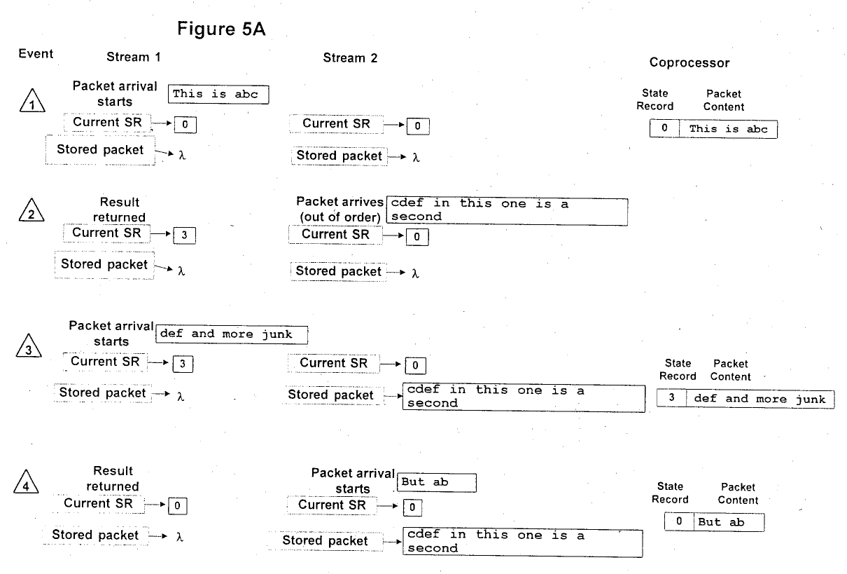

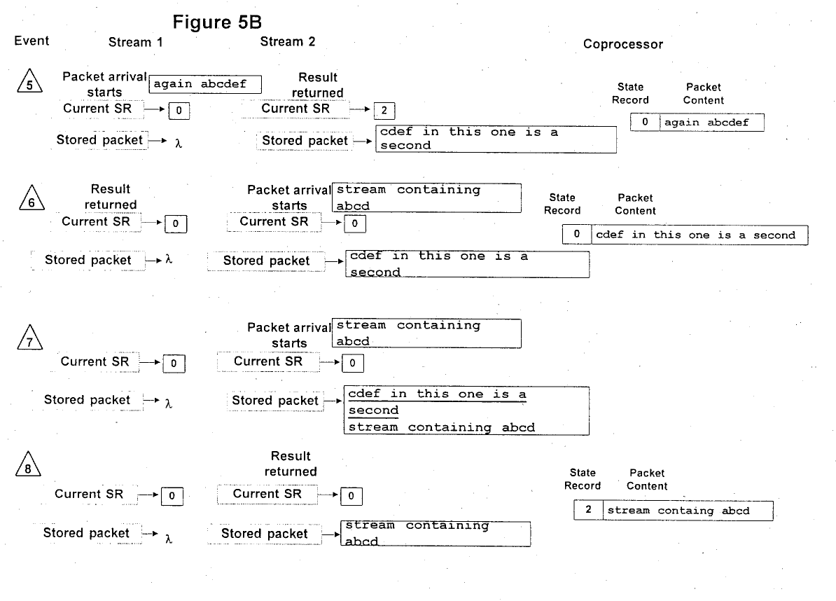

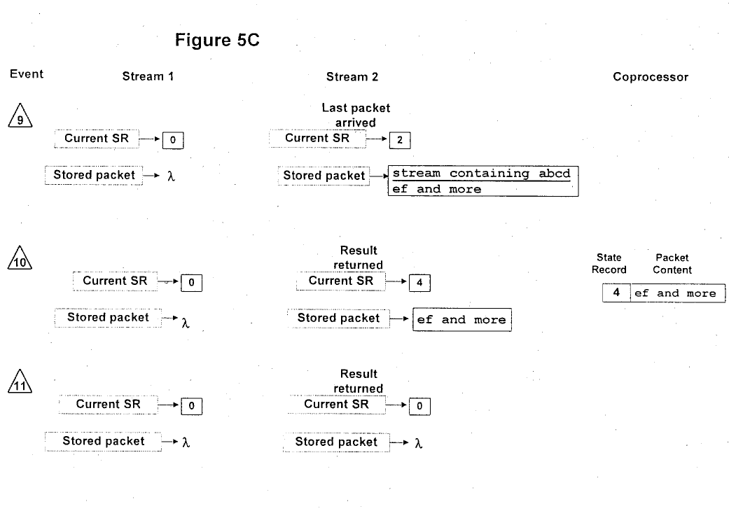

The next example illustrates (with reference to FIGS. 4, 5A, 5B and 5C) how two packetized data streams can be processed by a single processor. The packetized data streams are:

Stream 1: |This is abc|def and more junk| again abcdef|

Stream 2: |But ab|cdef in this one is a second |stream containing abcd|ef and more|

where packet boundaries are denoted by a vertical bar and they arrive interleaved as shown in FIG. 4.

In order to make this small example more realistic, a packet in stream 2 arrives out of order. The characters in the datastreams arrive serially and it is assumed that the coprocessor performs processing at the same speed as the character arrival rate. Events are indicated on the timeline with small solid triangles distinguished by unique integers. The events that may occur at each marker are:

Packet arrival starts

Packet processing starts

Packet arrival finishes

Packet is stored

Result returned

When a packet arrival starts it is either immediately sent to the coprocessor and processed as the bytes arrive or it is temporarily stored, because the coprocessor may be busy or the packet may be out of order in the datastream. The packets are assumed to arrive in a continuous flow without interruption or gaps.

The packets are handled by either a general purpose CPU or a special purpose processor designed to handle packets referred to as an NPU (Network Processor Unit).

FIG. 4 also shows the status of the coprocessor on the same time-line as the packets arrive. The designation S_{i,j} indicates that the coprocessor is processing the j^{th} packet from stream i. For example, the designation S_{2,3} means the coprocessor is working on the 3^{rd} packet from stream 2. The lack of a stream designation means the coprocessor is idle, which occurs when no packet is available for processing. In this example, the coprocessor is idle between event tags 2 and 3, because it is receiving an out of order packet in stream 2 and it has already processed

FIG. 5 shows the data structures associated with each stream and the coprocessor at each numbered event on the timeline in FIG. 4. The symbol λ is used to denote a null-pointer, which represents an empty stored packet list. The packet content is denoted inside a box. The current state record is an integer in this example, but in general it can be a more complicated structure when the coprocessor handles other types of automata, which may include history. The state record associated with the packet being processed is shown in FIGS. 5A, 5B and 5C for each of the marked event times. The events shown in FIGS. 4, 5A, 5B and 5C will now be described in words:

STEP 1:

Packet arrival starts—stream 1

Start processing packet from stream 1 ‘This is abc’

Stream 1: Current SR=0, Stored pkt=λ

Stream 2: Current SR=0, Stored pkt=λ

STEP 2:

Result returned—stream 1

Packet arrival starts—stream 2 (out of order)

Stream 1: Current SR=3, Stored pkt=λ

Stream 2: Current SR=0, Stored pkt=λ

STEP 3:

Packet arrival starts—stream 1

Store out of order packet—stream 2

Start processing packet from stream 1 ‘def and more junk’

Stream 1: Current SR=3, Stored pkt=λ

Stream 2: Current SR=0, Stored pkt=‘cdef in this one is a second’

STEP 4:

Packet arrival starts—stream 2

Result return—stream 1

Start processing packet from stream 2 ‘But ab’

Stream 1: Current SR=0, Stored pkt=λ

Stream 2: Current SR=0, Stored pkt=‘cdef in this one is a second’

STEP 5:

Result returned—stream 2

Packet arrival starts—stream 1

Start processing packet from stream 1 ‘again abcdef’

Stream 1: Current SR=0, Stored pkt=λ

Stream 2: Current SR=2, Stored pkts=‘cdef in this one is a second’

STEP 6:

Result returned—stream 1

Packet arrival starts—stream 2

Start processing stored packet from stream 2

Stream 1: Current SR=0, Stored pkt=λ

Stream 2: Current SR=0, Stored pkt=‘cdef in this one is a second’

STEP 7:

Store packet that has arrived from stream 2 ‘stream containing abcd’

Packet arrival starts—stream 2—start storing(processor is busy)

Stream 1: Current SR=0, Stored pkt=λ

Stream 2: Current SR=0, Stored pkt=‘cdef in this one is a second’

‘stream containing abcd’

STEP 8:

Result returned—stream 2

Start processing next stored packet from stream 2

Packet arrival starts—stream 2—start storing

Stream 1: Current SR=0, Stored pkt=λ

Stream 2: Current SR=0, Stored pkt=‘stream containing abcd’

STEP 9:

Last packet has finished in input stream—stream 2—store

Stream 1: Current SR=0, Stored pkt=λ

Stream 2: Current SR=2, Stored pkt=‘stream containing abcd’‘ef and more’

STEP 10:

Result returned—stream 2

Start processing stored packet from stream 2

Stream 1: Current SR=0, Stored pkt=λ

Stream 2: Current SR=4, Stored pkt=‘ef and more’

STEP 11:

Result returned—stream 2

Stream 1: Current SR=0, Stored pkt=λ

Stream 2: Current SR=0, Stored pkt=λ

The above is a relatively simple example of the operation of the system. It should be understood, that many practical system operate in an environment where the packets and the expressions are much more complex than the example given above.

When a desired expression has been located by the state machine 104A, in the simplest case processing of the particular packet by co-processor 104 stops and the network processor 103 is given an indication of the result that has been reached. The network processor 103 would then take some action that had been programmed into the network processor when the system was initialized. In a more typical operation after a particular expression is detected by the DFA 104A the operation on bits in the packet by the DFA would continue to either find another occurrence of the same set of bits or to find a different set of bits. Thus, in some embodiments, the result information transferred to the network processor 103 by the co-processor 104 will be very simple, while in other embodiments the results will be more complex. Processing bits in a particular connection can either terminate when a particular pattern is found or it may continue to find another occurrence of the same pattern or to find a different pattern. If in a particular embodiment, processing continues after a match is located, the state machine merely continues processing bits from the packet where the match was found, starting again at the “0” state.

It should be noted that the network configuration shown herein is merely an example of the type of network wherein the invention can be used. The present invention is applicable wherever it is necessary to process packets across packet boundaries.

While the specific embodiment described above uses an Intel IXP1200 Network processor and a co-processor, various other embodiments are possible. For example, other types of network processors could be used. Furthermore, while in the present embodiment, the actual processing is done by DFA 104A in coprocessor 104, it should be understood that the processing could be done by a DFA program subroutine or hardware located inside the router or network processor 103. Furthermore, it should be noted that the DFA 104A in the coprocessor could be implemented by hardware or by software in a conventional manner.

The specific embodiments shown utilize a DFA. It should be understood that alternate embodiments can be implemented using an NFA engine instead of a DFA engine.

As described above with respect to a more complex embodiment, the subexpression offsets plus the DFA state are referred to as a state record. The state record in general represents the complete state of the processing engine. The ‘state record’ allows the complete state of the machine to be restored so that an arbitrarily chosen virtual processing engine may be used to process a particular buffer. As used herein the term “state” means (a) either a single number which can represent the state for a simple embodiment or (b) a more complex state record which includes history that is required to represent the state for a complex embodiment. That is, the term “state” as used herein means either a single number or a more complex state record as required by the embodiment under consideration.

It is noted that packets in a connection may not arrive at the network processing engine in the order in which they were transmitted in the connection. Using conventional techniques, the network processor may rearrange the order of packets, prior to handing them off to the co-processor 104.

While the invention has been shown and described with respect to preferred embodiments thereof, it should be understood that various changes in form and detail may be made without departing from the spirit and scope of the invention.

I claim:

1) a method of processing packets across packet boundaries with a state machine, packets from multiple connections being interspersed in a common communication channel, said method comprising the steps of:
processing a packet from a particular connection with a state machine,
recording the state of said state machine when said packet has been processed,
transmitting the next packet from the same connection to said state machine,
transmitting said stored state to said state machine, and
initiating the processing of said next packet beginning at said stored state.

2) A system for processing communication packets traveling in a communication channel comprising,
a state machine for processing a series of bits to locate a desired pattern, said state machine having a plurality of states including an initial state, a plurality of intermediate states and a final recognition state,
means for storing the state of said state machine after the bits in a packet have been processes, and
means for initiating the processing of another packet at said stored state,
whereby packets can be recognized across packet boundaries.

3) A method of processing packets in a stream of packets which consists of interleaved packets from different connections, said packets including a header which indicates the connection to which the packet belongs,
detecting that a packet belongs to a particular connection,
processing said packet utilizing a state machine,
recording the state of said state machine at the end of processing said packet,
receiving another packet that belongs to said particular connection, and
beginning the processing of said another packet at said stored state,
whereby processing is continuous across packet boundaries.

4) The method recited in claim 1 wherein said state machine is a DFA.

5) The system recited in claim 2 wherein said state machine is a DFA.

6) The method recited in claim 3 wherein said state machine is a DFA.

7) The method recited in claim 1 wherein said method is performed by a network processing engine and a co-processor which includes a state machine, and wherein said network processor transfers packets and state information to said coprocessor and said state machine in said co-processor begins processing packets at the state indicated by the state information that is transmitted to said coprocessor with the packet being processed.

8) The system recited in claim 2 including a network processing engine and a coprocessor, said state machine being located in said co-processor, said network processor having associated memory for storing state data indicating the final recognition state of said state machine after the bits of a packet have been processed.

9) The method recited in claim 2 wherein said method is performed by a network processing engine and a co-processor which includes a state machine, and wherein said network processor transfers packets and state information to said coprocessor and said state machine in said co-processor begins processing packets at the state indicated by the state information that is transmitted to said coprocessor with the packet being processed.

10) A method of processing communication packets traveling in a communication channel that carries packets from multiple connections, said packets being processed by a state machine, said method comprising the steps of,
determining to which connection a packet belongs,
processing said packet with said state machine beginning at the state reached when the last packet from said same connection was processed, and
storing the state reached by a state machine when a packet is processed together with an indication of the connection to which a packet belongs,
whereby patterns that cross packet boundaries can be detected.

11) The method recited in claim 10 wherein said state machine is a DFA.

12) The method recited in claim 10 wherein said network processor is located in a unit in line with said communication channel and said state machine is located in a co-processor.

13) The method recited in claim 1 wherein said packets are packets in a TCP/IP network.

14) The method recited in claim 11 wherein said packets are packets in a TCP/IP network.

15) The method recited in claim 1 wherein both the final state of said state machine and at least some of the history of processing a packet by said state machine is recorded.

16) The method recited in claim 11 wherein both the final state of said state machine and at least some of the history of processing a packet by said state machine is recorded.
